(19) United States
(12) Patent Application Publication
(10) Pub. No.: US 2015/0332179 A1
(43) Pub. Date: Nov. 19, 2015

(54) METHOD AND SYSTEM FOR ENHANCING REAL ESTATE VALUE

(71) Applicant: Sandy Vergano, Oakland, CA (US)

(72) Inventor: Sandy Vergano, Oakland, CA (US)

(21) Appl. No.: 14/714,277

(22) Filed: May 16, 2015

Related U.S. Application Data
(60) Provisional application No. 61/994,268, filed on May 16, 2014.

(51) Int. Cl. G06Q 10/06; G06Q 50/16; G06Q 40/00

(52) U.S. Cl. CPC G06Q 10/063; G06Q 40/12; G06Q 50/16

(57) ABSTRACT

The present invention is directed to a method of technical steps developed for the purpose of analyzing the underlying income generated by leases in effect at an individual commercial real estate asset which result in the identification of specific instances of income deficiency which may be amended by the introduction of one or more collateralized instruments designed to supplement such deficiencies, resulting in the enhancement of the determined value of the asset.

### CROSS-REFERENCE TO RELATED APPLICATIONS

This application claims priority to U.S. Provisional Application Ser. No. 61/994,268, entitled “Method and System for Enhancing Real Estate Value”, filed May 16, 2014, the contents of which are incorporated herein by reference in their entirety.

### TECHNICAL FIELD

The present invention is directed to a method developed for the purpose of analyzing the underlying income generated by leases in effect at an individual commercial real estate asset which result in the identification of specific instances of income deficiency which may be amended by the introduction of one or more collateralized instruments designed to supplement such deficiencies, resulting in the enhancement of the determined value of the asset.

### BACKGROUND ART

Commercial real estate values have historically been determined by a number of valuation methodologies. Chief among such methodologies are the income capitalization approach and the discount cash flow approach, both of which are based on an analysis of the income stream generated by the asset being valued. In the commercial real estate arena, the income utilized in such valuation analyses is predominantly generated by the leases in effect at the property at the time such valuation occurs. Therefore, under the predominant valuation methodologies currently utilized to determine commercial real estate values, a direct correlation exists between the income generated by the leases in effect at the property and the value determined by an analyzing party.

However, due to the longer duration of many lease instruments (which sometimes extend decades), a problem may arise where the contractual rent obligations to be paid by a tenant to a landlord have been previously and permanently fixed at a level which is materially below then-current market rents. In such circumstances, the existence of the below-market rental stream generated by a legacy lease results in a lower overall property valuation than would be the case if all rents were increased to market levels. Without a means to supplement this below-market rent, the property owner is unable to achieve a more normalized value for the commercial real estate asset.

To date, a limited number of solutions have been proposed to help solve this problem, but each such solution has inherent flaws. For example, some lenders have allowed an affiliate of the property owner to enter into a “master lease” agreement which requires the affiliate to make payments to the property owner on specified terms. The inherent flaw in this approach has been that the likelihood of payment on such master lease has been remote, particularly after the lender has foreclosed on the property and the affiliated property owner no longer owns the property (which is also the time when the lender is most interested in payment). Without a means to make the likelihood of repayment more certain, there is strong support for the argument that the income should not be underwritten (or lent against) in the first place.

The present invention solves these problems in a unique and novel way by defining a series of technical steps as follows: first, analyze the specific streams of income generated by leases in effect at the asset; second, compare these income streams to more normalized (market) rents in effect at the time; third, generate a contractual instrument which is designed to supplement the suboptimal income streams identified by such analysis and fourth, associate collateral to such instrument to provide certainty of payment thereunder.

### SUMMARY OF THE INVENTION

The present invention is directed to a method of technical steps developed for the purpose of analyzing the underlying income generated by leases in effect at an individual commercial real estate asset which result in the identification of specific instances of income deficiency which may be amended by the introduction of one or more collateralized instruments designed to supplement such deficiencies, resulting in the enhancement of the determined value of the asset.

### DESCRIPTION OF THE DRAWINGS

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

FIG. 1 is a block diagram illustrating an example of one embodiment for a method of incorporating collateralized supplemental leases with traditional leases in the loan process for enhancing the value of real estate in accordance with the present invention; and

FIG. 2 is a schematic diagram illustrating how variations enhance rent value.

### DESCRIPTION OF EMBODIMENTS

It is well known in the real estate marketplace that most leases in effect at the predominant classes of commercial real estate (retail, office, industrial) have multi-year durations. Due in large measure to the considerable costs associated with establishing a commercial tenancy (including landlord's marketing and preparatory costs and tenant's relocation and start-up costs), a typical lease may have a term ranging from five to 50 years. Moreover, because the parties are contractually binding themselves to specified financial terms for a term of years, each has an interest in fixing the key economic terms of their relationship at the time of lease commencement. Therefore, the tenant's base rental obligations are typically set forth with specificity within the lease agreement at the time of execution, and are not changed for the duration of the lease agreement.

However, market conditions will inevitably change during the term of a tenancy. If market conditions improve after a lease is executed, the landlord is unable to take advantage of more favorable market conditions (that is, higher rent) since it has already committed the applicable space to a tenant at a specified rent for the term of that tenant's lease. Since the value of commercial real estate is generally derived directly from the income produced by the leases at the property, the result for the landlord is that potential value becomes trapped for the remainder of the lease term. The present invention solves this problem by teaching a method comprised of a series of technical steps developed for the purpose of analyzing the underlying income generated by leases in effect at an individual commercial real estate asset which result in the identification of specific instances of income deficiency which may be amended by the introduction of one or more collateralized instruments designed to supplement such deficiencies, resulting in the enhancement of the determined value of the asset.

In order to achieve this desired outcome, and in accordance with the method of the present invention, the following series of technical steps must be followed to procure and analyze information describing the income in effect at the commercial real estate asset being considered: First, detailed information must be obtained from the property owner for each lease in effect at the property, including tenant names, space being occupied, duration of lease, and rent amount to be paid. The procurement of this information can be accomplished in various forms. The most efficient method for obtain the required information is to establish a website that may be accessed by the property owner, through which specific information may be transmitted for analysis. Other less efficient methods of procurement could include an electronic transmission of the information from the property owner (such as by a spreadsheet attached to email), or the completion by the property owner of a physical spreadsheet containing fields for the necessary information and the subsequent delivery of such physical spreadsheet to the analyzing party.

Next, the analyzing party must transfer the information to a medium designed to assist in the analysis of such information. An example of such a medium is a spreadsheet containing a series of columns describing specific lease attributes (such as tenant name, duration of lease, rent, and space occupied) and further containing a series of rows for entry of information specific to the individual leases in effect at the property. Next, the analyzing party must obtain detailed information describing then-current market conditions for new leases for comparable space as exists at the property being analyzed. This market information can be obtained from a variety of sources, such as leasing brokers, appraisers or databases maintained by third-party information aggregators, which may be accessed on a one-time or subscription basis.

Next, the market data must be entered into the analysis medium in order to enable a comparison with the property-specific data obtained from the property owner, for the purpose of identifying in-place leases that exhibit rents which are lower than then-current market rents for the applicable space. The analysis medium may be coded with rules to enable an efficient means of identifying instances of deficiency (such as highlighting) and with additional rules to calculate the precise deficiencies identified. Next, an additional analysis must be completed to determine the extent of such deficiencies and whether, based on a variety of user-defined criteria, such deficiencies merit further consideration for supplementation. Such user-defined criteria may be coded directly into the analysis medium to enable automated calculations to be performed. As an example, a user might define a rule that only deficiencies greater than a specified percentage should be highlighted for further consideration.

Where the foregoing series of steps results in the identification of specific lease deficiencies that are likely to benefit from supplementation, further analysis must be conducted to assess the viability of each instance of proposed supplementation. This is accomplished by performing calculations designed to compare (1) the cost of supplementation for each instance of deficiency (the amount of supplemental rent required to bring the deficient rent into alignment with market rent) and (2) the value enhancement expected to be derived from such instance of supplementation. In certain cases, the results of these calculations might suggest that supplementation is not a cost-effective solution (that is, the cost of effectuating the supplementation exceeds the amount of enhanced value achieved by the implementation of such system).

To further illuminate this aspect of the analysis (viability), it is important to understand the broader contexts in which such analysis and supplementation is beneficial to the property owner. Commercial real estate values are particularly critical to the property owner during two major transaction types: a sale transaction and a financing transaction. In a typical sale transaction, the seller markets its asset seeking the highest sales price. Potential buyers will determine an offering price by reference to the current and future income generated from the asset in order to determine what return on its investment might be expected. Likewise, in a typical financing transaction, the property owner often seeks the maximum amount of loan proceeds available. The underwriting analysis for a conventional commercial real estate loan relies heavily on a detailed analysis of the in-place income currently generated by the asset, which will serve as both the source of, and collateral for, the repayment of the loan. The amount of loan proceeds available to a property owner (borrower) is generally constrained by both the appraised value of the property (lenders will typically not lend more than 80% of the appraised value) and by the property's debt service coverage ratio, which compares the net operating income generated by the property to the debt service burden imposed by the anticipated loan (lenders will typically require a debt service coverage ratio of at least 1.20:1.0).

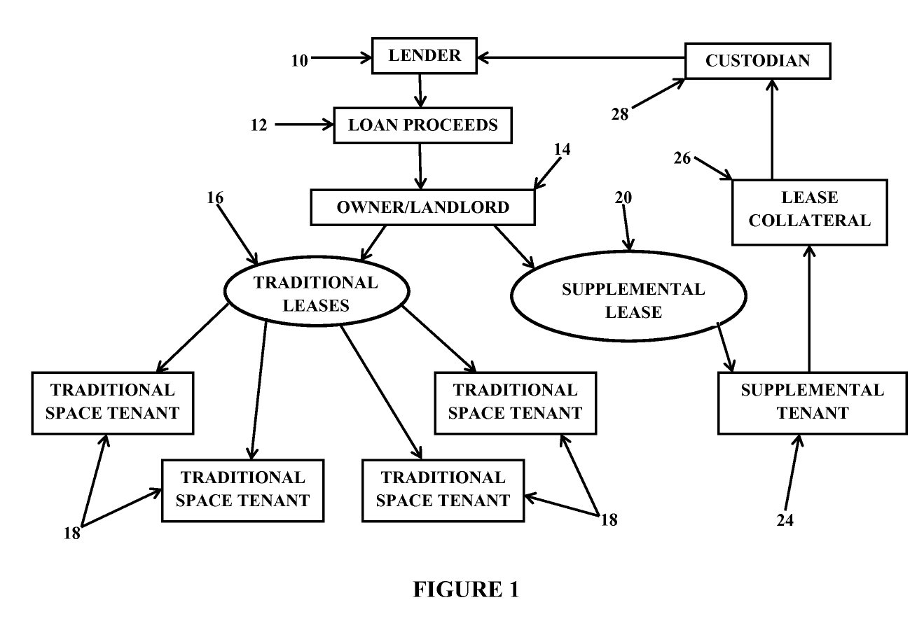

Referring now to FIG. 1, there is graphically illustrated a block diagram of an example of one embodiment for a method of enhancing the value of a commercial real estate asset (not shown) by the creation of one or more instruments to supplement the income stream generated by traditional tenant leases 16 (traditional leases) between the owner/landlord 14 and the traditional space tenants 18 (traditional tenants) in effect at the property at a given time. Therefore, in the context of either a sale transaction or a financing transaction such as a lender 10 distributing loan proceeds 12 to an owner landlord 14, a means of supplementing the income stream at the property (and thereby increasing the property's value) is particularly useful. But there are definable costs associated with effectuating a supplemental instrument; specifically, that a supplemental tenant 24 is contracting to make supplemental rental payments supported by lease collateral 26 at specified intervals, and in exchange for doing so, the supplemental tenant 24 must be compensated in an amount which is equal to or greater than the liability it is assuming by entering into a supplemental lease 20. Thus, in the context of a sale transaction, a supplemental lease 20 will generally be determined to be viable only if the additional value created by the introduction of the supplemental lease 20 (that is, the increased purchase price a seller/owner 14 will achieve) exceeds the amount which must be paid to the supplemental tenant 24 to compensate the supplemental tenant 24 for the liabilities being assumed by the execution of the supplemental lease 20. Similarly, in the context of a financing transaction, the supplemental lease 20 will generally be determined to be viable only if the additional value created by the introduction of the supplemental lease 20 (that is, the additional proceeds the property owner 14 will receive from its lender 10) exceeds the amount which must be paid to the supplemental tenant 24 to compensate it for the liabilities being assumed by the execution of the supplemental lease 20. Where, for the reasons described herein, the payments to be made under the supplemental lease 20 are to be collateralized by a mechanism designed to insure payment (such as the introduction of a custodian 28 to administer payments), the costs of effectuating such arrangement must also be considered in the context of the overall cost analysis. The calculations necessary to make such determinations require informational inputs based on real-time feedback from prospective buyers and lenders, which will change as market conditions evolve.

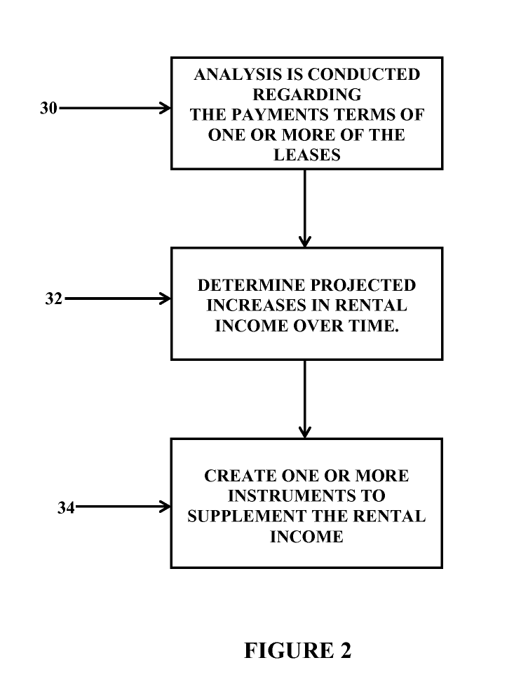

Next, where instances of supplementation are determined to be viable (cost effective), the means of supplementation itself must be determined and effectuated. In this context, “supplementation” generally means the creation of one or more instruments which generate a payment stream designed to increase the aggregate rental stream associated with a particular space (or in some cases the entire property) to align such rental stream more closely with what has been determined to be then-current market rent for such space (or property). To effectuate the determined supplementation, one or more instruments must be generated to evidence the obligation to make the calculated supplemental payments. As described above, one form of such instrument is a supplemental lease agreement 20 (supplemental lease) pursuant to which a party (supplemental tenant 24) agrees to make specified payments (supplemental rent) to the property owner (owner 14) on specified dates. Referring now to FIG. 2, in one embodiment of the present invention, an analysis is conducted regarding the payment terms of one or more of the traditional leases as shown in step 30 in effect at the subject property to determine the projected increases in rental income over time as shown in step 32. Subsequently, one or more instruments are created to supplement the rental income generated by the leases and thereby enhance the value of the underlying property as shown in step 34.

In another embodiment of the present invention, a relationship is established between the supplemental instrument and an existing traditional lease. This relationship may be beneficial in order to permit an evaluating party to more easily calculate the value enhancement created by the supplemental instrument. For example, the supplemental instrument described above might be implemented as an option contract relating to the space which is leased to a particular traditional tenant. The supplemental lease might therefore require the supplemental tenant to make specified payments to the owner in exchange for which the supplemental tenant is granted an option by the owner to occupy the space leased to the traditional tenant should certain conditions occur (such as if the traditional tenant defaults under the applicable traditional lease and vacates its space). The resultant association between the supplemental instrument and the underlying traditional lease would serve to simplify the valuation analysis, among other benefits.

In yet another embodiment of the present invention, no relationship is established between the supplemental lease and any existing traditional lease. Under this embodiment, the property is considered as a whole and a supplemental instrument is executed which contains no reference to any particular space at the property or to any particular existing traditional lease. The effect of this structure would be to further simplify the valuation analysis in that the value enhancing effects of the supplemental lease could be calculated without regard to the effects of association to a particular existing traditional lease and the terms thereof.

In another embodiment of the present invention, the supplemental lease would be structured to provide for fixed current payments that cease at a specified future date. For example, a particular traditional tenant 18 may be obligated to pay rent under a traditional lease 16 in an amount equal to $X per year in Lease Years 1 through 5 and in an amount equal to $X+$Y per year in Lease Years 6 through 10. A supplemental lease 20 is entered into which requires the supplemental tenant 24 to pay supplemental rent in an amount equal to $Y per year during the period of time that corresponds to Lease Years 1 through 5. The result is that the aggregate payments due from the traditional tenant 18 under the traditional lease 16 and from the supplemental tenant 24 under the supplemental lease 20 are an amount equal to $X+$Y per year for the full period of Lease Years 1 through 10.

In another embodiment of the present invention, the supplemental lease would be structured to provide for payments during a future time period. For example, assume a particular traditional tenant is obligated to pay rent in an amount equal to $X per year in Lease Years 1 through 5 but such traditional tenant's lease expires after Lease Year 5. A supplemental lease is entered into which requires supplemental tenant to pay supplemental rent in an amount equal to $Y per year for a 5-year period commencing immediately after the expiration of Lease Year 5. The result is that the sequential payments due from the traditional tenant under the existing traditional lease and from the supplemental tenant under the supplemental least are equal to $X+$Y per year for the full period of Lease Years 1 through 10. The effect of this payment structure would be to normalize projected income to mitigate potential cash flow disruptions implicated by the terms of one or more existing traditional leases.

In yet another embodiment of the present invention, the supplemental tenant's obligation to make future payments under the type of supplemental lease described in the immediately preceding paragraph would be conditioned on the occurrence or non-occurrence of certain events. For example, assume a particular traditional tenant is obligated to pay rent under a traditional lease in an amount equal to $X per year in Lease Years 1 through 5 and the traditional tenant has an option to extend its lease for an additional period of 5 years at rental rates equal to its initial term. A supplemental lease is entered into which requires supplemental tenant to make payments in an amount equal to $X per year for a 5-year period commencing immediately after the expiration of Lease Year 5 but the obligations under such supplemental lease are expressly conditioned on the non-exercise by the traditional tenant of its extension option. The result is that the payments due from the traditional tenant (if the extension option is exercised) or from the traditional tenant plus the supplemental tenant (if the extension option is not exercised) are equal to $X per year for the full period of Lease Years 1 through 10. The effect of this payment structure would be to normalize projected income to mitigate potential cash flow disruptions implicated by the terms of one or more existing traditional leases.

In still yet another embodiment of the present invention, the supplemental lease would contain termination provisions relating to the occurrence or non-occurrence of certain events. For example, assume a particular traditional tenant is obligated to pay rent under a traditional lease in an amount equal to $X per year in Lease Years 1 through 5 and the traditional tenant has an option to extend its lease for an additional period of 5 years in which case the traditional tenant would be obligated to pay rent under the (extended) traditional lease in an amount equal to $Y per year in Lease Years 6 through 10. A supplemental lease is entered into which requires the supplemental tenant to make payments in an amount equal to $Y-$X per year during the period of time that corresponds to Lease Years 1 through 5 and in an amount equal to $Y per year during the period of time that corresponds to Lease Years 6 through 10; however, the supplemental lease further provides that the supplemental tenant's obligations to make payments during the period of time that corresponds to Lease Years 6 through 10 will be terminated if the traditional tenant exercises its extension option. The result is that the payments due from a combination of the traditional tenant (under the traditional lease) and the supplemental tenant (under the supplemental lease) during Lease Years 1 through 5 are equal to $Y per year and that the payments due from either the traditional tenant (under the traditional lease) (if the extension option is exercised) or from the supplemental tenant (under the supplemental lease) (if the extension option is not exercised) are equal to $Y per year during Lease Years 6 through 10. The effect of this payment structure would be to normalize projected income to mitigate potential cash flow disruptions implicated by the terms of the existing lease.

As the previous discussion of viability suggests, the ultimate audience for the supplemental lease is less the property owner than a third party (either a buyer or a lender) who is relying on the supplemental lease for purposes of reaching its own conclusions about the value of the underlying property. Because of this dynamic, the buyer or lender will be particularly interested not only in the economic terms of the supplemental lease but also in the manner in which the supplemental lease is effectuated. For example, if a lender is agreeing to assign greater value to the property as a direct result of the existence of the supplemental lease, the lender has a vested interest in making sure the terms of the supplemental lease will be carried out as represented.

To date, a limited number of solutions have been proposed to guarantee payment on this front, but each such solution has inherent flaws. For example, some lenders have allowed an affiliate of the property owner to enter into a “master lease” agreement which requires the affiliate to make payments to the property owner on specified terms. The inherent flaw in this approach has been that the likelihood of payment on such master lease has been remote, particularly after the lender has foreclosed on the property and the affiliated property owner no longer owns the property (which is also the time when the lender is most interested in payment). Without a means to make the likelihood of repayment more certain, there is strong support for the argument that the income should not be considered in the first place. Therefore, additional steps can be taken to provide assurances to relying parties that the income stream derived from the supplemental lease will not be disrupted or eliminated at a later date. One such step is to introduce a disinterested third party intermediary to serve as the supplemental tenant to provide greater certainty that the payments under the supplemental lease will be made.

Another such step is the collateralization of the payment obligations under the supplemental lease. The amount of collateral required could range from a percentage of the aggregate payments required under the supplemental lease to the full amount of all payments required thereunder. For example, assume the supplemental tenant is required to make payments under a supplemental lease in an amount equal to $X per year over a 5-year period. The supplemental lease could require the supplemental tenant to post a deposit in an amount equal to the product of five and $X to provide security for the supplemental tenant's payments obligations. The effect of such collateralization would be to reduce the risk that the supplemental tenant would lack the necessary financial resources to fulfill its payment obligations when due, thereby providing an evaluating party (such as a potential buyer or lender) assurance that the payment obligations under a supplemental instrument will be paid in accordance with its terms.

Still another step related to the immediately preceding step (in which the supplemental tenant is required to post collateral to secure its payment obligations under the supplemental lease) is the imposition of a requirement that the collateral be deposited with an independent third party custodian (28 on FIG. 1). This step would provide further assurances to the relying party that the payments required to be made under the supplemental lease will not be disrupted as a result of extraneous activities engaged in by the supplemental tenant.

Referring now to FIG. 1, in still yet another embodiment of the present invention, where the supplemental tenant 24 is required to post collateral 26 to secure its payment obligations under the supplemental lease 20, the collateral 26 is deposited with an independent third party custodian 28 (custodian). For example, assume the supplemental tenant 24 is required to post a total deposit of $T to secure its obligations arising under a supplemental lease 20 over a 5-year period. The supplemental lease 20 could require the supplemental tenant 24 to post its deposit ($T) with the custodian 28. The supplemental tenant 24, the custodian 28 and the owner 14 would agree upon the terms and conditions pursuant to which the custodian 28 holds the deposit. Under one embodiment, the custodian 28 would agree to forward periodic payments on behalf of the supplemental tenant 24 to the owner 14 from the deposit held by the custodian 28. The effect of this arrangement would be to reduce the risk that the supplemental tenant 24 might elect to divert the designated funds toward another purpose, thereby providing an evaluating party (such as a potential buyer or lender) further assurance that the payment obligations under a supplemental lease will be paid in accordance with its terms.

In still yet another step that could be taken to provide greater certainty that the payments under the supplemental lease will be made as anticipated is the imposition of a requirement that a third party provide a guaranty to support the supplemental tenant's payment obligations under the supplemental lease. The amount of such guaranty and the credit characteristics of the party providing the guaranty could vary based on a variety of factors. For example, assume the supplemental tenant is required to make payments under the supplemental lease in an amount equal to $X per year over a 5-year period. The supplemental lease could require the supplemental tenant to provide a guaranty from a third-party guarantor in an amount equal to the full amount of the supplemental tenant's payment obligations under the supplemental lease. The effect of such guaranty would be to provide a backstop to support the financial obligations of the supplemental tenant, thereby providing an evaluating party (such as a potential buyer or lender) further assurance that the payment obligations under the supplemental lease will be paid in accordance with its terms.

Each of the foregoing steps would require a series of procedures designed to effectuate the specific means of assurance being utilized in a particular transaction. A common element in this process is the creation of the underlying instrument itself, the supplemental lease. Once the business terms have been settled upon, a legal document must be drafted that embodies the obligations precisely as calculated. In particular, the document must obligate the supplemental tenant to make payments of supplemental rent pursuant to a specific payment schedule that matches the numerical conclusions reached during the assessment stage of the process. Moreover, in many instances additional features must be properly associated with the supplemental lease in order to assure that the terms will be followed as contemplated. For example, where the obligations under the supplemental lease are to be collateralized to provide assurances of payment, the process of collateralizing such obligations will require a series of additional steps, including the following: (1) identifying and procuring acceptable and adequate collateral, (2) associating such collateral with the supplemental lease, (3) identifying an appropriate third-party custodian qualified to hold and administer such collateral, and (4) entering into additional agreements among applicable parties designed to effectuate the arrangement and to clearly define each party's rights and responsibilities. In addition, once the transaction has been consummated, additional steps must be taken to track performance of the supplemental tenant under the supplemental lease to insure that the agreed-upon terms are being carried out as contemplated.

It is contemplated for embodiments of the invention to extend to individual elements and concepts described herein, independently of other concepts, ideas or system, as well as for embodiments to include combinations of elements recited anywhere in this application. Although illustrative embodiments of the invention have been described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. Thus, the absence of describing combinations should not preclude the inventor from claiming rights to such combinations.

In general, the routines executed to implement the embodiments of the invention, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of machine or computer-readable media used to actually effect the distribution. Examples of computer-readable media include but are not limited to recordable type media such as volatile and non-volatile memory devices, USB and other removable media, hard disk drives, optical disks (e.g., Compact Disk Read-Only Memory (CD ROMS), Digital Versatile Disks, (DVDs), etc.), and flash drives, among others.

Although the present invention has been described with reference to specific exemplary embodiments, it will be evident that the various modification and changes can be made to these embodiments without departing from the broader spirit of the invention. Accordingly, the specification and drawings are to be regarded in an illustrative sense rather than in a restrictive sense.

What is claimed is:

1. A method for enhancing a commercial real estate asset's value, comprising the steps of:
determining an initial value of a commercial real estate asset based on analyzing thean income stream derived from rent payable by tenants under leases in effect at said commercial real estate asset; and
increasing said determined initial value by creating of one or more instruments to supplement said income stream generated by said tenant leases.

2. The method according to claim 1, further comprising the step of:
determining said initial value of said commercial real estate wherein said commercial real estate is retail space.

3. The method according to claim 1, further comprising the step of:
determining said initial value of said commercial real estate wherein said commercial real estate is office space.

4. The method according to claim 1, further comprising the step of:
determining said initial value of said commercial real estate wherein said commercial real estate is industrial space.

5. The method according to claim 1, further comprising the step of:
determining said initial value by obtaining detailed information on said commercial real estate owner for each lease in effect at said commercial real estate, including tenant names, space being occupied, duration of lease, and rent amount to be paid.

6. The method according to claim 1, further comprising the step of:
determining said initial value by additionally obtaining detailed information describing then-current market conditions for new leases for comparable space as exists for said commercial real estate being analyzed.

7. The method according to claim 1, further comprising the step of:
increasing said determined initial value only if it is determined to be cost effective based on a set of defined criteria.

8. The method according to claim 1, further comprising the step of:
increasing said determined initial value by effectuating a supplemental instrument wherein a supplemental tenant enters into a contract with said commercial real estate owner to make supplemental rental payments at specified intervals.

9. The method according to claim 1, further comprising the step of:
increasing said determined initial value by associating collateral with such supplemental instruments as to provide greater certainty of performance.

10. The method according to claim 1, further comprising the step of:
increasing said determined initial value by introducing a disinterested third party to hold such collateral and utilize such collateral to make the payments required under such supplemental instruments as to provide yet greater certainty of performance.

11. The method according to claim 1, further comprising the step of:
increasing said determined initial value by effectuating a supplemental instrument wherein an option contract relating a space leased to a tenant, wherein said tenant makes specified payments to said commercial real estate owner in exchange for which said tenant is granted an option by said owner to occupy space leased to said tenant should certain conditions occur.

12. The method according to claim 1, further comprising the step of:
increasing said determined initial value by effectuating a supplemental instrument wherein said supplemental instrument is executed and contains no reference to any particular space at said commercial real estate or to any particular existing traditional lease.

13. The method according to claim 1, further comprising the step of:
increasing said determined initial value by effectuating a supplemental instrument having termination provisions relating to an occurrence or non-occurrence of certain events.

14. The method according to claim 1, further comprising the step of:
increasing said determined initial value by effectuating a supplemental instrument entered into and guaranteed by a third party.

15. The method according to claim 1, further comprising the step of:
increasing said determined initial value by effectuating a supplemental instrument entered into and guaranteed by a buyer for said commercial real estate.

16. The method according to claim 1, further comprising the step of:
increasing said determined initial value by effectuating a supplemental instrument entered into and guaranteed by a seller for said commercial real estate.
